(19) United States
(12) Patent Application Publication
(10) Pub. No.: US 2012/0255394 A1
(43) Pub. Date: Oct. 11, 2012

(54) CENTRIFUGAL PENDULUM MECHANISM

(75) Inventors: Stephan Maienschein, Baden-Baden (DE); Christian Huegel, Rheinau (DE); Stefan Jung, Kehl (DE); David Schnaedelbach, Buehl (DE)

(73) Assignee: SCHAEFFLER TECHNOLOGIES AG & CO. KG, Herzogenaurach (DE)

(21) Appl. No.: 13/528,170

(22) Filed: Jun. 20, 2012

Related U.S. Application Data
(63) Continuation of application No. PCT/DE2010/001453, filed on Dec. 13, 2010.

(30) Foreign Application Priority Data
Dec. 21, 2009 (DE) 102009059755.7
May 25, 2010 (DE) 102010021410.8

(51) Int. Cl. F16F 15/14

(52) U.S. Cl. 74/574.2

(57) ABSTRACT

The invention relates to a centrifugal pendulum mechanism, having at least one pendulum mass support and at least one pendulum mass arranged thereon, which pendulum mass can be moved to a limited extent radially relative to the pendulum mass support by means of at least one rolling element inside raceways formed by recesses in the pendulum mass support and the pendulum mass and in the circumferential direction, the rolling element having guiding means formed in the gap between the individual pendulum mass and the pendulum mass support. The invention includes means for reducing the gap size between the pendulum mass and the pendulum mass support in an at least spatially limited manner are provided outside the raceways for the rolling element and outside the range of the intermediate space between the pendulum mass and the pendulum mass support that can be converted by the guiding means.

### CROSS-REFERENCE TO RELATED APPLICATIONS

This application is filed under 35 U.S.C. §120 and §365(c) as a continuation of International Patent Application No. PCT/DE2010/001453, filed Dec. 13, 2010, which application claims priority from German Patent Application No. 10 2009 059 755.7, filed Dec. 21, 2009, and German Patent Application No. 10 2010 021 410.8, filed May 25, 2010, which applications are incorporated herein by reference in their entireties.

### FIELD OF THE INVENTION

The invention relates to a centrifugal pendulum mechanism having at least one pendulum mass support and at least one pendulum mass arranged thereon, which pendulum mass is movable by means of at least one rolling element to a limited extent in a radial direction and in a circumferential direction relative to the pendulum mass support inside tracks formed by recesses in the pendulum mass support.

### BACKGROUND OF THE INVENTION

In drive trains, absorbers that are adaptable to a wide range of rotational speeds, preferably to the entire speed range of the driving engine, are used to dampen vibrations. They are capable of absorbing torsional vibration over a wide range of speeds, ideally over the entire speed range of the driving engine due to the fact that they are designed and arranged in a way to ensure that their natural frequency is proportional to the rotational speed. Such absorbers operate according to the principle of a centrifugal pendulum in a centrifugal-force field. They include a pendulum mass support that is rotatable about an axis of rotation and inert or pendulum masses swingingly arranged about the axis of rotation of the pendulum mass support. When a rotary movement is introduced, the individual pendulum masses strive to circulate about the axis of rotation at a maximum possible distance. The torsional vibrations result in a relative swinging movement of the pendulum masses. Different systems are known in the art: systems in which the pendulum masses carry out a purely translatory movement on a circular path of movement relative to the axis of introduction of the rotary movement and systems in which the path of movement has a radius of curvature that changes at least in sections as the pendulum masses are increasingly deflected out of their central position.

Published German Patent Application No. 10 2006 028 556 A1 discloses a centrifugal pendulum mechanism of this general type in a drive train of a motor vehicle. The mechanism includes a rotatable pendulum mass support and pendulum masses that are arranged thereon in opposing pairs. The pendulum masses are movable to a limited extent relative to the pendulum mass support by means of rolling elements. For this purpose, the rolling elements are movable to a limited extent in tracks formed by recesses in the pendulum mass support and in the pendulum masses. For example, the recesses are formed as continuous longitudinal holes with a kidney-shaped curvature. Between the pendulum mass support and the respective adjacent pendulum mass, the rolling elements have a guide means provided in the region between pendulum mass and pendulum mass support, for example, in the shape of a collar or shoulder for guiding the pendulum mass as it moves relative to the pendulum mass support and for preventing the pendulum mass from hitting the pendulum mass support. Due to the axial width of such guide means, which are formed to be integral with the rolling element or are connected to the latter so as to be fixed against rotation relative thereto, a minimum distance between the facing surfaces of pendulum mass and pendulum mass support is generated. This distance cannot be reduced at will without impeding the rolling motion. The resultant spaced distance between the pendulum mass support and an individual pendulum mass surface facing the pendulum mass support is comparatively wide. Thus, the pendulum mass may tilt relative to the pendulum mass support, causing a considerable problem in particular at low speeds with inherently low centrifugal forces. If this happens, the functioning of the centrifugal force pendulum is compromised in this speed range and is not reliably reproducible for a repeat case. The tilting may additionally cause damage to the individual components and their connections as well as to the swinging support of the pendulum mass on the pendulum mass support.

### BRIEF SUMMARY OF THE INVENTION

An object of the invention is to provide an improved centrifugal pendulum mechanism that reduces the tilting tendency of the individual pendulum masses relative to the pendulum mass support and provides enhanced stability.

In one embodiment, a centrifugal pendulum mechanism includes at least one pendulum mass support, at least one pendulum mass arranged thereon, at least one rolling element extending through the pendulum mass and through the pendulum mass support to receive the pendulum mass inside tracks formed by recesses in the pendulum mass support and in the pendulum mass in a way for the pendulum mass to be movable to a limited extent in the radial direction and in the circumferential direction relative to the pendulum mass support, the rolling element including a guide means provided in the gap between pendulum mass and pendulum mass support, where means for reducing a gap distance between pendulum mass and pendulum mass support at least in a locally limited way are provided outside the tracks for the rolling element and outside the region coverable by the guide means in the gap between pendulum mass and pendulum mass support upon a rolling movement of the rolling element.

The gap between a single pendulum mass and the pendulum mass support is understood to be the space that extends in the axial direction and is formed in the radial direction and in the circumferential direction between a pendulum mass and the pendulum mass support. The position of the gap varies as a function of the position of the individual pendulum mass upon its deflection under the influence of the centrifugal force. The width of the gap, which defines the axial distance between pendulum mass and pendulum mass support, is measured between the respective facing surfaces of the pendulum mass and of the pendulum mass support. The width of the gap may be constant across the entire extension of an individual pendulum mass front face facing towards the pendulum mass support. Alternatively, the width of the gap may vary in the direction of extension in the radial direction and/or in the circumferential direction.

A reduction in the sense of the invention is understood to be a shortening of the axial width of the gap; yet despite the shortening, a minimum gap is always maintained to avoid negative effects on the functioning of the centrifugal pendulum due to friction between pendulum mass and pendulum mass support upon deflection due to the influence of centrifugal forces. That is to say that the mans are designed and arranged in a way to ensure that even in an unloaded condition of the centrifugal pendulum, the individual pendulum mass and the pendulum mass support do not contact each other. The minimum distance is selected as a function of the field of use of such a centrifugal pendulum mechanism.

The means provided in accordance with the invention at least locally attain a reduction of the gap distance between pendulum mass and pendulum mass support, thus reducing the theoretically possible tilting angle, avoiding undesired tilting of the individual pendulum masses, for example, at low rotational speeds, and increasing the stability of the centrifugal pendulum on the whole.

In terms of the arrangement and design of the means for an at least locally limited reduction of the gap distance, two basic embodiments can be distinguished. The first basic embodiment includes at least one or more means of this type, each of which is arranged and effective only in at least one part of the gap between pendulum mass and pendulum mass support. An advantage of this embodiment is that a gap reduction is attainable in a specific location. The number and/or geometry and/or dimensions and/or arrangement of the means in the gap are selected as a function of the geometry and dimensions of the centrifugal pendulum, for example, of the individual pendulum mass. As the means are smaller than the individual pendulum mass in terms of their dimensions, standardized spacer elements that are integratable into the means for spacing apart the pendulum mass and the pendulum mass support can preferably be used independently of their geometry.

In a first embodiment, the means for reducing the gap distance between pendulum mass and pendulum mass support at least in a locally limited way are arranged in a way to be symmetrical relative to the pendulum mass.

In a second embodiment, the means for reducing the gap distance at least in a locally limited way are formed to extend over the entire extension of the gap in the radial direction and in the circumferential direction outside the tracks for the rolling element and the region that is passable by the guide means between the pendulum mass and the pendulum mass support upon a rolling movement of the rolling element. An advantage of this embodiment is that a constant gap distance is set between pendulum mass and pendulum mass support.

In terms of the association of the means to the individual gap-forming components, there are basically three options. In a first option, the means for reducing the gap distance at least in a locally limited way are associated with the pendulum mass and are preferably coupled to or formed on the pendulum mass. An advantage of this association is that it is a simple way of increasing the mass of the pendulum. An association with the pendulum mass permits the use of standardized pendulum mass supports and avoids modifications to the latter.

In a second option, the means for reducing the gap distance at least in a locally limited way are associated with the pendulum mass support and are preferably coupled to or formed on the latter. This embodiment permits taking into account the requirement of such means for reducing the gap width at least in a locally limited way when the pendulum mass support is manufactured. Depending on the type and design of these means, they can be integrated into the pendulum mass support in one process step.

The third option is a combination of the two aforementioned options. This option may partly combine the advantages of the two options.

In terms of the design of the individual means for reducing the gap distance at least in a locally limited way, two alternatives can be distinguished. One alternative envisages the use of separate add-on elements. A second alternative envisages forming the means as an integral part of at least one of the components pendulum mass and/or pendulum mass support.

In the first alternative, the means for reducing the gap width at least in a locally limited way are retroactively integratable into existing centrifugal pendulum devices, i.e., they can be retrofit. Depending on the selected design, add-on elements in the shape of standardized elements may be used in a preferable way. Such standardized elements are easy to be kept in stock and are easy to connect at least indirectly to the pendulum mass or to the pendulum mass support.

In one sub-feature of the first alternative, the means include at least one add-on element in the form of a washer, which may be a standardized component. Such add-on elements are easy to arrange between pendulum mass and pendulum mass support without requiring modifications. The washers may be connected to the pendulum mass support or to an individual pendulum mass. Alternatively, if they are sufficiently fixed in position, for example, using axial stop surfaces that are present in any case on a spacer bolt, then they may be loosely inserted and held in the gap by the connection between the pendulum mass and the axial end region of the spacer bolt.

In another sub-feature, the means include at least one add-on element that forms at least one protrusion projecting into the gap. The add-on element may be embodied as one of the components listed below: ball, cylinder pin, bolt, shell-shaped element, rivet head, etc. This list is not final. Any add-on element may be used that is easy to connect to the pendulum mass support or to an individual pendulum mass and interacts with the former or the latter to form a protrusion extending into the gap.

In yet another sub-feature, an add-on element, for example, a disc-shaped element, is used that extends over the entire surface of the individual pendulum mass on the front face facing the pendulum mass support with the exception of the tracks and an area around the tracks that is coverable by the individual guide means. This embodiment includes a constant gap distance in the entire pendulum mass area in the un-deflected state.

In all of the aforementioned embodiments, the add-on elements are connected to the respective components (pendulum mass or pendulum mass support) in a force-fitting, form-fitting, or material-locking way.

If the individual pendulum mass is coupled to the pendulum mass support via a spacer element or if the centrifugal pendulum mechanism includes the fact that two respective pendulum masses are arranged on a pendulum mass support in opposing pairs and are coupled to each other and defined in their positions relative to each other by spacer bolts, such a spacer element, which is provided in any case, or a spacer bolt may be used preferably to fix the means for reducing the gap distance, and thus, combining two functions.

In the second alternative, the means for reducing the gap distance at least in a locally limited way are formed integrally with the pendulum mass and/or with the pendulum mass support. They may be created in various ways.

In the first embodiment, locally limited protrusions extending in the axial direction may be created to reduce the gap distance by suitable shaping or machining of the surface of the pendulum mass and/or of the pendulum mass support. In one sub-feature, at least one area may be embodied as a coined element formed at least in sections on the pendulum mass and/or on the pendulum mass support. The coined elements form protrusions directed into the gap. An area around the track of the pendulum mass and/or of the pendulum mass support is coined on at least in sections and the guide means is receivable in the recess formed by the coined element. Thus, the pendulum mass may be arranged closer to the pendulum mass support and the installation space that the centrifugal pendulum mechanism requires is reduced.

In another sub-feature, the means for reducing the gap distance at least in a locally limited way are formed by at least one semi-piercing on a pendulum mass and/or on the pendulum mass support. Semi-piercings are created by a displacement of material under pressure and corresponding deformation. The semi-piercings are to be arranged in such a way that the resultant protrusions formed on the opposing front faces of pendulum mass and/or pendulum mass support due to the displacement of material are located outside the tracks for the rolling element and outside the area passable by the guide means. The creation of semi-piercings permits a targeted and simple arrangement of axial protrusions in the desired way to reduce the distance.

A centrifugal pendulum mechanism that is designed in accordance with the invention is usable, for example, in a torsional vibration damper in a drive train of a motor vehicle. The torsional vibration damper includes an input part, an output part rotatable relative to the input part to a limited extent against the action of energy storage elements, and one or more damper stages. The centrifugal pendulum device may be arranged on a disc part of the damper stage, for example, on the input part, on a potential intermediate part, or on the output part.

The centrifugal pendulum mechanism of the invention is also usable in a torque converter with a torsional vibration damper with a centrifugal pendulum mechanism arranged thereon. The torsional vibration damper that includes the centrifugal pendulum mechanism may be arranged inside a housing of the torque converter.

Further advantageous fields of use are dual mass flywheels, double clutches, wet clutches, or dry clutches.

### BRIEF DESCRIPTION OF THE SEVERAL VIEWS OF THE DRAWING

The nature and mode of operation of the present invention will now be more fully described in the following detailed description of the invention taken with the accompanying drawing figures, in which:

FIG. 1 is a front view of a section of a centrifugal pendulum mechanism;

FIG. 2a is a cross-sectional view taken along a line A-A of FIG. 1 of a prior art embodiment of a centrifugal pendulum mechanism;

FIG. 2b is a cross-sectional view taken along a line B-B of FIG. 1 of a prior art embodiment of a centrifugal pendulum mechanism;

FIG. 2c is a cross-sectional view taken along a line C-C of FIG. 1 of a prior art embodiment of a centrifugal pendulum mechanism;

FIG. 3a is a view of section A-A of FIG. 1 of a first embodiment of a first alternative of a second basic embodiment of a centrifugal pendulum mechanism of the invention;

FIG. 3b is a view of section B-B of FIG. 1 of a first embodiment of a first alternative of a second basic embodiment of a centrifugal pendulum mechanism of the invention;

FIG. 3c is a view of section C-C of FIG. 1 of a first embodiment of a first alternative of a second basic embodiment of a centrifugal pendulum mechanism of the invention;

FIG. 4a is a view of section A-A of FIG. 1 of an embodiment of a first alternative of a first basic embodiment of a centrifugal pendulum mechanism of the invention;

FIG. 4b is view of section B-B of FIG. 1 of an embodiment of a first alternative of a first basic embodiment of a centrifugal pendulum mechanism of the invention;

FIG. 4c is a view of section C-C of FIG. 1 of an embodiment of a first alternative of a first basic embodiment of a centrifugal pendulum mechanism of the invention;

FIG. 5a illustrates a development of a first alternative of a first basic embodiment of FIG. 4a;

FIG. 5b is a view B-B of FIG. 1 for a further development of a first alternative of a first basic embodiment;

FIG. 5c illustrates a further development of a first alternative of a first basic embodiment of FIG. 4c;

FIG. 6 is a view in accordance with section A-A of FIG. 1 of a second embodiment of a first alternative of a first basic embodiment of a centrifugal pendulum mechanism of the invention;

FIG. 7 is a view of section B-B of FIG. 1 of a third embodiment of a first alternative of a first basic embodiment of a centrifugal pendulum mechanism of the invention;

FIG. 8a is a view of section A-A of FIG. 1 of a first embodiment of a second alternative of a first basic embodiment of a centrifugal pendulum mechanism of the invention;

FIG. 8b is a view of section B-B of FIG. 1 of a first embodiment of a second alternative of a first basic embodiment of a centrifugal pendulum mechanism of the invention;

FIG. 8c is a view of section C-C of FIG. 1 of a first embodiment of a second alternative of a first basic embodiment of a centrifugal pendulum mechanism of the invention;

FIG. 9a is a view of section A-A of FIG. 1 of a further embodiment of a second alternative of a first basic embodiment of a centrifugal pendulum mechanism of the invention;

FIG. 9b is a view of section B-B of FIG. 1 of a further embodiment of a second alternative of a first basic embodiment of a centrifugal pendulum mechanism of the invention;

FIG. 9c is a view of section C-C of FIG. 1 of a further embodiment of a second alternative of a first basic embodiment of a centrifugal pendulum mechanism of the invention; and,

FIG. 10 is a view of section A-A in FIG. 1 of a further embodiment of a second alternative of a first basic embodiment of a centrifugal pendulum mechanism of the invention.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

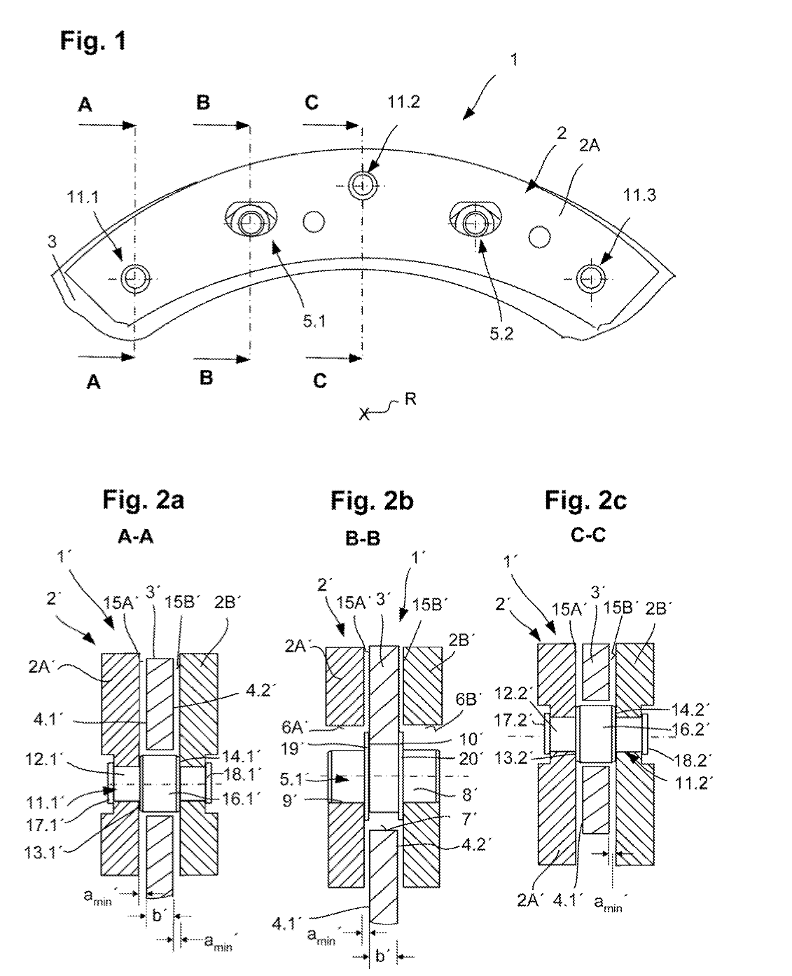

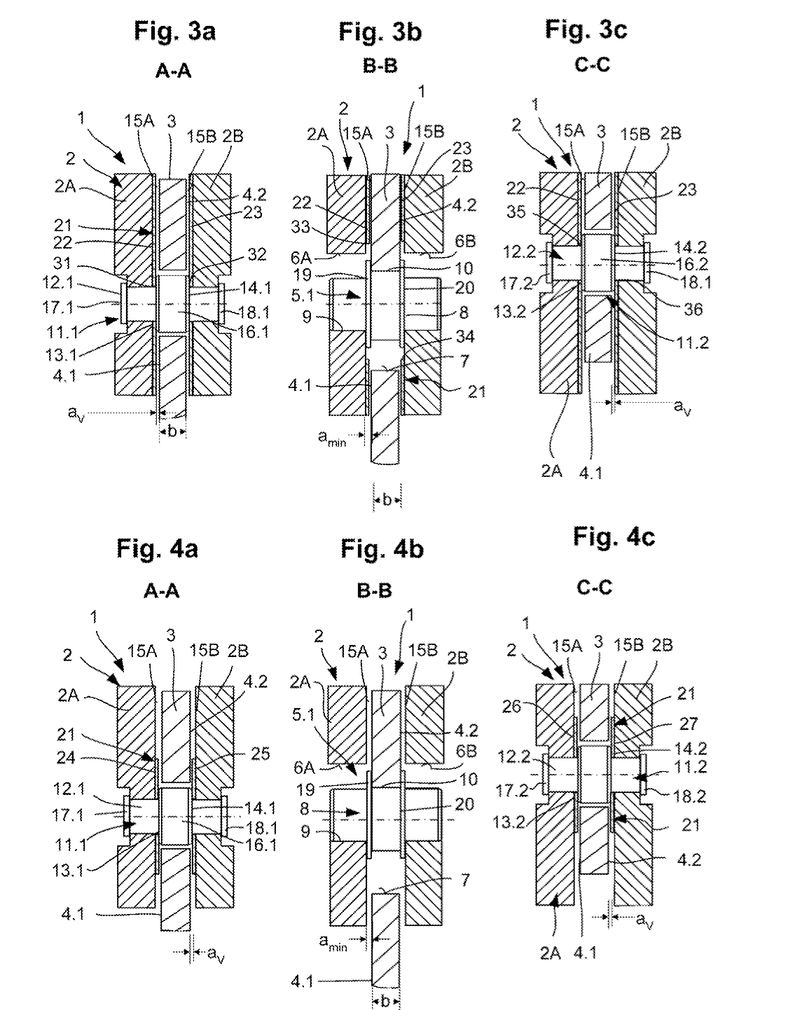

FIG. 1 is a simplified diagrammatic front view of a section of a speed-adaptive absorber designed as centrifugal pendulum mechanism 1 in accordance with the invention. Centrifugal pendulum mechanism 1 preferably includes multiple inert masses that act as pendulum masses 2 and are swingingly supported on rotatable pendulum mass support 3 so as to be movable relative thereto. Pendulum mass support 3 is preferably shaped like an annular disc. Individual pendulum masses 2 are circumferentially arranged thereon about axis of rotation R at regular intervals. In the illustrated section, only one pendulum mass 2A of pendulum mass unit 2 is shown. Axis of rotation R is only indicated for a better understanding and is not drawn to scale. In one embodiment, the support of individual pendulum masses 2A, 2B on pendulum mass support 3 is described for the individual alternatives of the two basic embodiments in the sectional views A-A, B-B, C-C of FIGS. 3 to 10. The sectional views A-A, B-B, C-C of FIGS. 2a to 2c illustrate the tilting problem of pendulum masses 2A′, 2B′ relative to pendulum mass support 3′ in prior art centrifugal pendulum device 1′. In these Figures, a “′” is added to the reference numerals of the individual components.

In all these embodiments, pendulum masses 2A, 2B are arranged in respective opposing pairs on both sides of front faces 4.1 and 4.2 of pendulum mass support 3. Individual pendulum masses 2A, 2B are of an essentially circular ring segment shape. Pendulum masses 2A, 2B that oppose each other on front faces 4.1, 4.2 of the pendulum mass support are connected to each other to form single pendulum mass unit 2. Here, the connections are indicated by reference numerals 11.1, 11.2, 11.3. Connections 11.1 and 11.2, respectively, are represented in sectional views A-A and C-C of FIG. 1 in the following figures. By analogy, the explanations pertaining to connections 11.1, 11.2 also apply to connection 11.3. In the simplest case, the individual connections are achieved by a connecting element, which simultaneously acts to set the distance between two pendulum masses 2A, 2B forming a pair. Preferably, spacer bolt 12.1 is used for connection 11.1 and spacer bolt 12.2 is used for connection 11.2. Each spacer bolt 12.1, 12.2 passes through pendulum mass support 3. Spacer bolts 12.1, 12.2 create a firm connection between two pendulum masses 2A, 2B, thus, forming pendulum mass unit 2. For this purpose, individual spacer bolts 12.1, 12.2 are designed as step pins having two respective axial stop surfaces 13.1, 14.1 and 13.2, 14.2, respectively, for two facing front faces 15A, 15B of two pendulum masses 2A, 2B. Spacer bolt portion 16.1, 16.2 that passes through pendulum mass support 3 is designed to be larger than width a of pendulum mass support 3, thus, creating spaced distance a on both sides between pendulum masses 2A, 2B and pendulum mass support 3. As explained above, the dimensions of this distance a are determined by the width of portion 16.1, 16.2, respectively, the position of axial stop surfaces 13.1, 14.1 and axial stop surfaces 13.2, 14.2 for spacer bolt 12.2, and width b of pendulum mass support 3. The attachment of individual pendulum mass 2A, 2B on spacer bolt 12.1, 12.2 is achieved in a force-fitting and/or form-fitting way, for instance using axial securing elements for locking individual pendulum mass 2A, 2B relative to axial stop surfaces 13.1, 14.1 and 13.2, 14.2, respectively. In one embodiment, the attachment may be implemented in a non-releasable form-fitting way using rivet connections 17.1, 18.1 and 17.2, 18.2, respectively. For this purpose, the rivets are integrally formed on spacer bolt 12.1, 12.2 and are created during assembly.

The oscillating support of individual pendulum mass 2A, 2B is achieved using at least one pendulum bearing assembly. In the present example, two pendulum bearing assemblies 5.1, 5.2 are provided. They include rolling elements 8 designed as rolling bodies or idler rollers guided on a corresponding track. The construction of a pendulum bearing assembly will be explained with reference to pendulum bearing assembly 5.1, which is illustrated in a sectional view B-B in the following figures. In the illustrated example, a movement of individual pendulum mass 2A, 2B relative to pendulum mass support 3 is made possible by rolling elements 8 that are guided in tracks 6A, 6B and 7 and are designed as rolling bodies or idler rollers. Tracks 6A, 6B are formed as recesses in respective pendulum mass 2A, 2B, i.e., track 6A is a recess in pendulum mass 2A and track 6B is a recess in pendulum mass 2B. Track 7 is formed as a recess in pendulum mass 3. In the simplest case, the recess is in the shape of through-holes having a geometry that matches the desired contour of tracks 6A, 6B, or 7. For example, on individual pendulum masses 2A, 2B, it is conceivable to provide tracks 6A, 6B embodied as depressions formed in pendulum masses 2A, 2B. The geometry and dimensions of individual tracks 6A, 6B, 7 determine the acceptable freedom to move of individual pendulum mass 2A, 2B. Guide means 19, 20 for axially guiding and securing individual rolling elements 8 on pendulum mass support 3 are provided on individual rolling element 8. Guide means 19, 20 may be embodied as a radial extension. In the illustrated example, guide means 19, 20 are integral with rolling element 8 and form shoulders. Guide means 19, 20 that face each other in pairs on rolling element 8 are preferably arranged at a suitable axial distance to each other that essentially corresponds to width b of pendulum mass support 3 in an area about track 7. The distance between these guide means 19, 20 and the width of these guide means 19, 20 determine respective minimum distance aₘᵢₙ between individual pendulum mass 2A, 2B, respectively, and pendulum mass support 3 in the area of pendulum bearing assembly 5.1, 5.2. Minimum distance aₘᵢₙ cannot be reduced at will. The greater distance aₘᵢₙ, the greater the risk that individual pendulum masses 2A, 2B may tilt sideways under certain operating conditions; a phenomenon that frequently occurs on both sides at low centrifugal forces, i.e., at a low rotational speed.

FIGS. 2a to 2c illustrate the coupling of individual pendulum masses 2A′, 2B′ to pendulum mass support 3 of the prior art as shown in the three sectional views A-A, B-B, and C-C of FIG. 1. The figures illustrate required minimum distance aₘᵢₙ′ between pendulum mass 2A′, 2B′ and pendulum mass support 3′. Minimum distance aₘᵢₙ′ is required over the entire extension of pendulum mass 2A′, 2B′ relative to pendulum mass support 3 because of the axial width of guide means 19′, 20′. In the other views A-A and C-C shown in FIGS. 2a and 2c, minimum distance aₘᵢₙ′ is likewise present between pendulum mass 2A′, 2B′ and pendulum mass support 3′. Due to the size of minimum distance aₘᵢₙ′, there is always a risk that pendulum masses 2A, 2B may tilt relative to pendulum mass support 3′. This may have undesired effects. Thus, the invention proposes to eliminate or at least reduce the risk of tilting. In one embodiment, this is attained using means 21 for reducing the axial distance between pendulum mass support 3 and pendulum masses 2A, 2B arranged thereon at least in a locally limited way. Such means may be embodied in different ways. A distinction is made between embodiments in which means 21 are formed integrally with pendulum masses 2A, 2B and/or with pendulum mass support 3 and embodiments in which means 21 are separate devices.

The first alternative includes the use of separate add-on elements. The views in the following figures correspond to sectional views A-A, B-B and C-C of FIG. 1.

FIGS. 3a to 3c illustrate a first alternative of a second basic embodiment in the aforementioned sectional views A-A, B-B, C-D of FIG. 1. FIG. 3a represents a sectional view A-A of FIG. 1. In this embodiment, means 21 include a respective add-on element in the form of disc-shaped element 22, 23. Each of these add-on elements is arranged between pendulum mass support 3 and pendulum mass 2A, 2B arranged on respective front face 4.1 or 4.2 of pendulum mass support 3. The add-on elements in the form of disc-shaped elements 22 and 23 are designed and arranged in a way to be arranged over the entire extension of respective facing front faces 15A, 15B of individual pendulum masses 2A, 2B in the radial and circumferential directions. In the region of the formation of tracks 6A, 6B and 7, in the region passable by guide means 19, 20 in the gap and in the region of the through-holes for the connecting elements of connections 11.1, 11.2, the add-on elements are recessed. For easy manufacturing, the add-on elements are preferably designed as sheet metal disc components. They cover almost the entire surface of front faces 15A, 15B of individual pendulum masses 2A, 2B and are shaped to match the outer contour of pendulum masses 2A, 2B.

FIG. 3a illustrates the view A-A of FIG. 1. This illustration shows that the individual add-on elements rest against the entire surface of front faces 15A, 15B of pendulum masses 2A, 2B and are arranged between pendulum masses 2A, 2B and axial stop surfaces 13.1, 13.2 of spacer bolt 12.1. The figure also shows through-holes 31, 32 for the axial end regions of spacer bolt 12.1 and resultant reduced distance a_{V} between pendulum mass 2A, 2B and pendulum mass support 3. The add-on elements in the form of disc-shaped elements 22, 23 are assigned to pendulum masses 2A, 2B and are fixed thereto. The fixing is achieved by means of spacer bolt 12.1, which is present in any case. Spacer bolt 12.1 has axial end regions that are designed to be suitable for forming a rivet head to form rivet connection 17.1, 18.1.

FIG. 3b is a sectional view B-B through pendulum bearing assembly 5.1. This view illustrates required minimum distance aₘᵢₙ between pendulum mass support 3 and individual pendulum mass 2A, 2B. Distance aₘᵢₙ needs to be maintained in the region of guide means 19, 20 and in the region the guide means pass upon a rolling movement of rolling element 8. It can be seen that individual disc-shaped element 22, 23 is recessed in these regions to provide minimum distance aₘᵢₙ for this region; that is to say that disc-shaped element 22, 23 includes openings or through-holes 33, 34, which are preferably greater than the region to be kept clear or which may exactly match the geometry of the region that is passed upon a movement. The recesses are dimensioned in such a way that they are designed to maintain a distance for receiving guide means 19, 20 when rolling elements 8 rest on the respective rolling surfaces on radially inward rolling surface 9 or on radially outward rolling surface 10. Guide means 16 must be prevented from getting into contact with the add-on elements at all times.

The sectional view C-C of FIG. 1 shown in FIG. 3c illustrates the arrangement of the add-on elements in the region of connection 11.2. The basic construction corresponds to the embodiment shown in FIG. 3a. Disc-shaped elements 22, 23 have through-holes 35, 36 for receiving spacer bolt 12.2. In this case, too, the connection is a rivet connection. The rivet connections are designated by numbers 17.1, 18.2. This Figure also shows reduced distance aᵥ.

The add-on elements in the form of disc-shaped elements 22, 23 are arranged and designed in such a way that their surfaces are always at same reduced distance aᵥ in the ideal position relative to pendulum mass support 3. It is likewise conceivable to provide elevations or depressions in the surface facing pendulum mass support 3; and thus, the resultant gap may vary in terms of its width in the radial and/or circumferential direction.

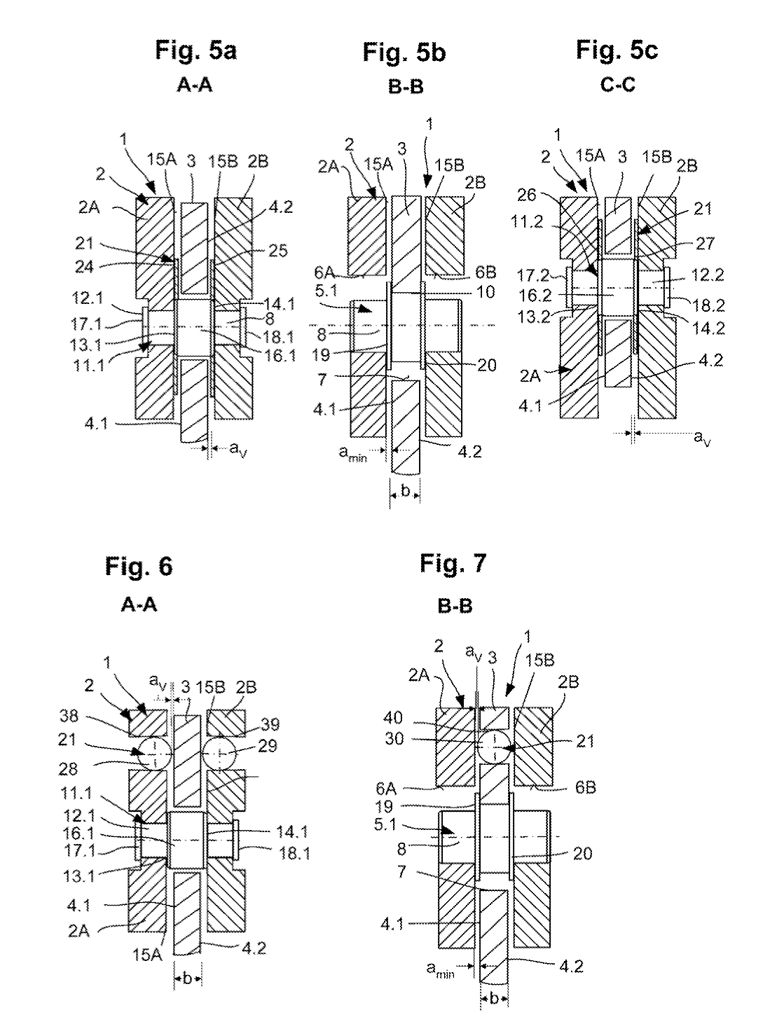

Compared to the embodiments shown in FIGS. 3a to 3c, FIGS. 4a to 4c illustrate a first alternative of a first basic embodiment in which means 21 do not include add-on elements embodied as elements that cover entire front faces 15A, 15B of pendulum masses 2A, 2B. Instead, add-on elements in the form of washers 24, 25 and 26, 27 are arranged in a locally limited way. The washers are riveted on both sides between pendulum mass 2A, 2B and spacer bolt 12. The add-on elements in the form of washers 24 to 27 are arranged only in the region of rotationally fixed connections 11.1, 11.2 and, in analogy, 11.3. Although the add-on elements are arranged only in a partial region of the gap, they permit a reduction of the distance in this region, thus, preventing tilting over entire pendulum mass unit 2 due to the arrangement of connections 11.1, 11.2, 11.3 between individual pendulum masses 2A, 2B. Each one of individual connections 11.1, 11.2, 11.3 of individual pendulum masses 2A and 2B of pendulum mass unit 2 includes the introduction of washers 24, 25 of this kind in FIG. 4a and of washers 26, 27 in FIG. 4c. The region of pendulum bearing assemblies 5.1 (shown in FIG. 4b) and 5.2 (not illustrated) is free of such washers.

FIG. 4a is an axial section through connection 11.1. Washer 24 is arranged between axial stop surface 13.1 and pendulum mass 2A. Washer 25 is arranged between pendulum mass 2B and axial stop surface 14.1. It can be seen that the outer diameter of washers 24, 25 needs to be greater than that of through-hole 37, through which spacer bolt 12.1 passes through pendulum mass support 3. The interior diameter of individual washers 24, 25 is preferably adapted to the diameter of the axial end regions of spacer bolt 12.1.

FIG. 4b illustrates the sectional view B-B of FIG. 1 for this embodiment. The figure shows that in this region, no washers or space-filling elements are provided.

In a way analogous to FIG. 4a, FIG. 4c illustrates the axial section C-C of FIG. 1 for connection 11.2. Here, too, washers 26 and 27 are provided on both sides of pendulum mass support 3 between axial stop surfaces 13.2, 14.2 and pendulum masses 2A, 2B. The attachment to pendulum masses 2A, 2B is done analogously with the embodiment shown in FIG. 4a.

In the illustrated example, for individual connections 11.1 to 11.3, the add-on elements in the form of washers 24 to 27 are arranged in a way to hit axial stop surfaces 13.1, 13.2 and 14.1, 14.2 in spacer bolt 12.1, 12.2. To achieve a reduction of the axial distance, spacer bolt 12.1, 12.2 with its region 16.1, 16.2 is designed to be of smaller width than in a prior art embodiment as shown in FIGS. 2a to 2c.

FIGS. 5a to 5c illustrate a further development of the first alternative of the first basic embodiment shown in FIGS. 4a to 4c. In this embodiment, axial stop surfaces 13.1, 13.2 and 14.1, 14.2 are embodied as stop surfaces for individual pendulum masses 2A, 2B, with washers 24, 25 and 26, 27 being loosely arranged in the space between pendulum mass support 3 and individual pendulum masses 2A, 2B. What is to be ensured, however, is that washers 24 and 25 do not hit the pendulum mass support 3. For this reason, in the regions of axial stop surfaces 13.1, 13.2 and 14.1, 14.2, spacer bolts 12.1 and 12.2, respectively, are designed in a way that they likewise fix washers 24, 25 and (for the embodiment of FIG. 5c) 26, 27 in position. In the simplest case, the washers are designed to be supported in the region of the chamfer or pressed onto spacer bolt 12.1, 12.2.

Further alternatives of the first alternative of the first basic embodiment are shown in FIGS. 6 and 7. They include the provision of separate add-on elements 28, 29 or 30 that are integrated or supported in the individual components of pendulum mass 2A, 2B and/or pendulum mass support 3. These add-on elements may be of different designs such as balls, half-shells, cylinder pins, or the like, which form at least one axial protrusion extending into the gap. The crucial aspect is that they create an axial extension into the gap between pendulum mass 2A, 2B and pendulum mass support 3.

Based on a sectional view through connection 11.1 of section A-A of FIG. 1, FIG. 6 illustrates an integration of such add-on elements 28 and 29 in the form of spherical elements supported or fixed in corresponding receiving elements 38, 39 on individual pendulum masses 2A, 2B. With respect to the width of individual pendulum masses 2A, 2B, add-on elements 28, 29 are arranged on or integrated in pendulum masses 2A, 2B in a way to form a respective axially protruding projection on respective facing front faces 15A, 15B of individual pendulum masses 2A, 2B. The add-on elements may be arranged on pendulum masses 2A, 2B in any desired way. The crucial aspect is that the resultant locally-limited distance reduction is achieved outside the motion range of guide means 19, 20 in the gap.

In contrast, FIG. 7 illustrates an alternative arrangement of such add-on elements. In this sectional view of section B-B of FIG. 1, an add-on element 30 that is likewise designed as a spherical element is arranged in receiving element 40 on pendulum mass support 3. Add-on element 30 is arranged and dimensioned to form an axial protrusion into the gap.

The embodiments shown in FIGS. 6 and 7 are merely examples. Means 21 may include any desired add-on elements that are suitable for forming axially protruding regions on pendulum masses 2A, 2B and/or on pendulum mass support 3. They may be movably supported on pendulum masses 2A, 2B or on pendulum mass support 3, or they may be fixed thereto or integral therewith. If they are fixed, the connection may be a force-fitting, form-fitting, or material-locking connection. The type of arrangement depends on the required regions of reduced distance in the gap that are to be created.

The number, geometry and dimensions of the regions of locally-limited distance reduction to be created by the add-on elements are selected to match the requirements of the individual case.

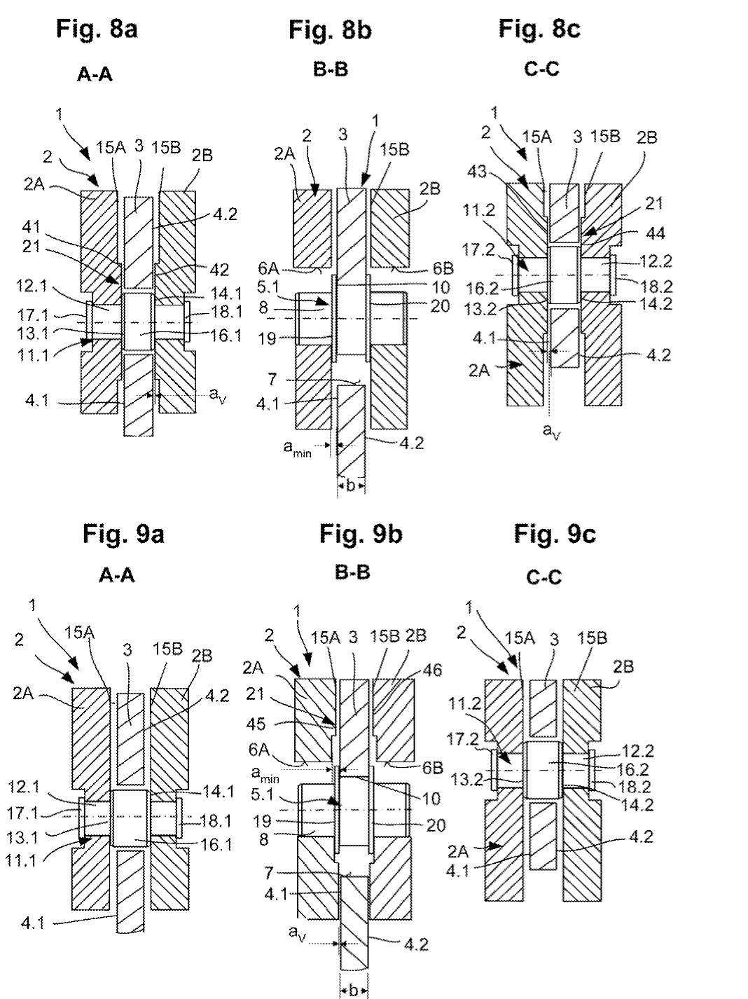

FIGS. 8 to 10 illustrate embodiments of a second alternative of a first basic embodiment in which means 21 are integral with at least one of the components of pendulum mass 2A, 2B and/or pendulum mass support 3.

FIGS. 8a and 8c illustrate the locally limited arrangement of coined elements 41, 42 provided on pendulum masses 2A, 2B in the region of connection 11.1 and of coined elements 43, 44 provided on pendulum masses 2A, 2B in the region of their connection 11.2 effected by spacer bolt 12.2. Coined elements 41, 42 and 43, 44 are arranged in the region of the through-holes for spacer bolt 12.1 and 12.2, respectively, through pendulum masses 2A, 2B. In the radial direction, they are dimensioned so that their outer circumference is arranged on a greater diameter with respect to spacer bolt 12.1, 12.2 than the diameter of the through-hole on the pendulum mass support 3. In the illustrated example, coined elements 41, 42 are embodied to rest against axial stop surfaces 13.1, 14.1, and coined elements 43, 44 are embodied to rest against axial stop surfaces 13.2, 14.2. Here, the regions of reduced distance aᵥ are created between coined elements 41 and 43 on pendulum mass 2A, and respectively, coined elements 42 and 44 on pendulum mass 2B and pendulum mass support 3. Coined elements 41 to 44 preferably define flat surfaces directed towards the pendulum mass support. The region of pendulum masses 2A, 2B arranged about coined elements 41, 42 and 43, 44, respectively, is free from such coined elements and acts to provide the required distance in the range of motion of guide means 19, 20 of rolling element 8 between pendulum mass 2A, 2B and pendulum mass support 3.

Coined elements 41, 42, 43, and 44 need not necessarily be arranged as shown in FIGS. 8a to 8c. They may be arranged in a different location on pendulum mass 2A, 2B. The only thing to ensure is that the range of motion of guide means 19, 20 of rolling element 8 remains clear.

FIG. 8b illustrates pendulum bearing assembly 5.1, which is free from such coined elements.

In contrast to the embodiment shown in FIGS. 8a to 8c, FIGS. 9a to 9c illustrate a further embodiment in which coined elements forming means 21 are not arranged on pendulum masses 2A, 2B, but on pendulum mass support 3. Coined elements 45 and 46 are arranged on pendulum mass support 3 outside the region of track 7 and the regions passable by guide means 19, 20 in the gap. Coined elements 45, 46 thus form a depression in the receiving region of rolling element 8 and of the tracks. This depression includes the required minimum distance for the reception of guide means 19, 20.

Coined elements 45, 46 on pendulum mass support 3 are preferably arranged in the region about the tracks of individual pendulum bearing assemblies 5.1, 5.2. The remaining areas are preferably clear. This can be seen in the sectional views A-A and C-C of FIGS. 9a and 9c.

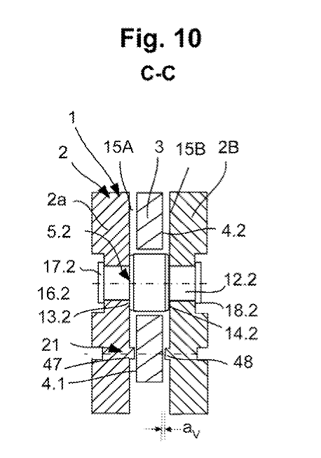

In another embodiment of locally limited surfaces for locally reducing the gap distance is shown in FIG. 10 in a sectional view A-A of FIG. 1. In this embodiment, the local protrusions that extend into the gap in the axial direction are formed as semi-piercings 47 and 48, each of which is provided on both pendulum masses 2A, 2B. Semi-piercings 47, 48 are preferably formed on the individual pendulum masses. A (non-illustrated) arrangement on pendulum mass support 3 is conceivable.

The arrangement of the semi-piercings may be at random. Again the crucial aspects are that the motion range of guide means 19, 20 in the gap must not be compromised and that furthermore the protrusion is arranged opposite a counter-surface on the other element, i.e., in the illustrated example, pendulum mass support 3. Consequently, the semi-piercings will always be arranged outside through-holes on pendulum mass support 3.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### LIST OF REFERENCE SYMBOLS

1′, 1 centrifugal pendulum mechanism
2′, 2 pendulum mass unit
2A′, 2A pendulum mass of a pendulum mass unit
2B′, 2B pendulum mass of a pendulum mass unit
3′, 3 pendulum mass support
4.1′, 4.1 front face
4.2′, 4.2 front face
5.1′, 5.1 pendulum bearing assembly
5.2′, 5.2 pendulum bearing assembly
6A, 6B track
6A′, 6B′ track
7′, 7 track
8′, 8 rolling element
9′, 9 radially inward rolling surface
10′, 10 radially outward rolling surface
11.1′, 11.1 rotationally fixed connection
11.2′, 11.2 rotationally fixed connection
11.3′, 11.3 rotationally fixed connection
12.1′, 12.1 spacer bolt
12.2′, 12.2 spacer bolt
13.1′, 13.1 axial stop surface
14.1′, 14.1 axial stop surface
13.2′, 13.2 axial stop surface
14.2′, 14.2 axial stop surface
15A′, 15A front face of a pendulum mass
15B′, 15B front face of a pendulum mass
16.1′, 16.1 portion
16.2′, 16.2 portion
17.1′, 17.1 rivet connection
17.2′, 17.2 rivet connection
18.1′, 18.1 rivet connection
18.2′, 18.2 rivet connection
19′, 19 guide means
20′, 20 guide means
21 means for reducing the gap distance at least in a locally limited way
22, 23 disc-shaped elements
24, 25 washers
26, 27 washers
28 add-on element
29 add-on element
30 add-on element
31 through-hole
32 through-hole
33 through-hole
34 through-hole
35 through-hole
36 through-hole
37 through-hole
38 receiving element
39 receiving element
40 receiving element
41 coined element
42 coined element
43 coined element
44 coined element
45 coined element
46 coined element
47 semi-piercing
48 semi-piercing
R axis of rotation
b width of pendulum mass support
aₘᵢₙ′ distance
aᵥ reduced distance

What is claimed is:

1. A centrifugal pendulum mechanism (1) comprising:
at least one pendulum mass support (3);
at least one pendulum mass (2A, 2B) arranged thereon; and,
at least one rolling element (8) extending through said pendulum mass (2A, 2B) and through said pendulum mass support (3) to receive the pendulum mass (2A, 2B) inside tracks (6A, 6B, 7) formed by recesses in said pendulum mass support (3) and in said pendulum mass (2A, 2B) in a way for said pendulum mass (2A, 2B) to be movable to a limited extent in the radial direction and in the circumferential direction relative to the pendulum mass support (3), the rolling element (8) including a guide means (19, 20) provided in the gap between pendulum mass (2A, 2B) and pendulum mass support (3), wherein means (21) for reducing a gap distance between pendulum mass (2A, 2B) and pendulum mass support (3) at least in a locally limited way are provided outside the tracks (6, 6B, 7) for the rolling element (8) and outside the region coverable by the guide means (19, 20) in the gap between pendulum mass (2A, 2B) and pendulum mass support (3) upon a rolling movement of the rolling element (8).

2. The centrifugal pendulum mechanism (1) as recited in claim 1, wherein the means (21) for reducing the gap distance at least in a locally limited way are arranged at least in a partial region of the gap between pendulum mass (2A, 2B) and the pendulum mass support (3).

3. The centrifugal pendulum mechanism (1) as recited in claim 1, wherein over the entire extension of the gap in the radial direction and in the circumferential direction, the means (21) for reducing the gap distance at least in a locally limited way are arranged outside the tracks (6A, 6B, 7) for the rolling element (8) and outside the area passable by the guide means (19, 20) between pendulum mass (2A, 2B) and pendulum mass support (3) upon a rolling movement of the rolling element (8).

4. The centrifugal pendulum mechanism as recited in claim 1, wherein the means (21) for reducing the gap distance at least in a locally limited way are coupled to the pendulum mass (2A, 2B) or formed on the latter.

5. The centrifugal pendulum mechanism as recited in claim 1, wherein the means (21) for reducing the gap distance at least in a locally limited way are coupled to or formed on the pendulum mass support (3).

6. The centrifugal pendulum device (1) as recited in claim 1, wherein the means (21) for reducing the gap distance at least in a locally limited way comprise at least one add-on element (22, 23, 24, 25, 26, 27, 28, 29, 30) that is connected to or supported on the pendulum mass (2A, 2B) or the pendulum mass support (3).

7. The centrifugal pendulum device (1) as recited in claim 1, wherein the means (21) for reducing the gap distance at least in a locally limited way comprise at least one add-on element (22, 23, 24, 25, 26, 27, 28, 29, 30) that is connected to or supported on the pendulum mass (2A, 2B) and the pendulum mass support (3).

8. The centrifugal pendulum mechanism (1) as recited in claim 6, wherein the individual add-on element (22, 23, 24, 25, 26, 27, 28, 29, 30) is embodied as one of the following:
a washer (24, 25, 26, 27);
an element forming an axial protrusion, for example balls, rolling bodies, pin, in particular cylinder pin, rivet head (28, 29, 30);
a disc element (22, 23) extending over the entire surface of the pendulum mass (2A, 2B) outside the tracks (6A, 6B, 7) for the rolling element (8) and outside the region passable by the guide means (19, 20) upon a rolling movement of the rolling element (8).

9. The centrifugal pendulum mechanism (1) as recited in claim 1, wherein the individual pendulum mass (2A, 2B) is coupled to the pendulum mass support (3) by a spacer element or wherein two respective pendulum masses (2A, 2B) are arranged as an opposing pair on a pendulum mass support (3), their positions relative to each other being fixed by at least one spacer bolt (12.1, 12.2) passing through the pendulum mass support (3), and wherein the attachment of the means (21) for reducing the gap distance at least in a locally limited way is achieved using the spacing element or the spacer bolt (12.1, 12.2) or using the axial securing elements connected thereto or provided thereon.

10. The centrifugal pendulum mechanism (1) as recited in claim 1, wherein the individual pendulum mass (2A, 2B) is coupled to the pendulum mass support (3) by a spacer element and wherein two respective pendulum masses (2A, 2B) are arranged as an opposing pair on a pendulum mass support (3), their positions relative to each other being fixed by at least one spacer bolt (12.1, 12.2) passing through the pendulum mass support (3), and wherein the attachment of the means (21) for reducing the gap distance at least in a locally limited way is achieved using the spacing element or the spacer bolt (12.1, 12.2) and using the axial securing elements connected thereto or provided thereon.

11. The centrifugal pendulum mechanism (1) as recited in claim 1, wherein the means (21) for reducing the gap distance at least in a locally limited way are integrally formed on the pendulum mass (2A, 2B) or on the pendulum mass support (3).

12. The centrifugal pendulum mechanism (1) as recited in claim 1, wherein the means (21) for reducing the gap distance at least in a locally limited way are integrally formed on the pendulum mass (2A, 2B) and on the pendulum mass support (3).

13. The centrifugal pendulum mechanism (1) as recited in claim 11, wherein the means (21) comprise at least one of the following embodiments:
at least one coined element (41, 42, 43, 44, 45, 46) on the pendulum mass (2A, 2B) or on the pendulum mass support (3);
at least one semi-piercing (47, 48) formed on an front face (15A, 15B, 4.1, 4.2) of the pendulum mass (2A, 2B) and/or on the pendulum mass support (3) and forming a protrusion extending in the axial direction.

14. The centrifugal pendulum mechanism (1) as recited in claim 11, wherein the means (21) comprise at least one of the following embodiments:
at least one coined element (41, 42, 43, 44, 45, 46) on the pendulum mass (2A, 2B) and on the pendulum mass support (3);
at least one semi-piercing (47, 48) formed on an front face (15A, 15B, 4.1, 4.2) of the pendulum mass (2A, 2B) and on the pendulum mass support (3) and forming a protrusion extending in the axial direction.
